(19) United States
(12) Patent Application Publication
(10) Pub. No.: US 2023/0163584 A1
(43) Pub. Date: May 25, 2023

(54) BUSBAR STRUCTURE WITH METAL BODY THAT PROTECTS AGAINST BURNING

(71) Applicant: EAE ELEKTRIK ASANSOR ENDUSTRISI INSAAT SANAYI VE TICARET ANONIM SIRKETI, Istanbul (TR)

(72) Inventors: Vedat VOSKI, Istanbul (TR); Çaglar ÇAG, Istanbul (TR); Hidir GÖGÜLTER, Istanbul (TR)

(21) Appl. No.: 17/549,249

(22) Filed: Dec. 13, 2021

(30) Foreign Application Priority Data
Nov. 25, 2021 (TR) 2021/018507

(51) Int. Cl. H02G 5/10; H01B 7/18; H02G 5/06

(52) U.S. Cl. CPC H02G 5/10; H01B 7/1805; H02G 5/06

(57) ABSTRACT

A busbar structure with a metal body, which ensures better discharge of the internal heat generated by the busbars during normal operation, prevents combustion and stops the progression of combustion, in environments that require the power line to be IP68 against the environmental water threat and where IP68 busbar structures are used.

### CR0SS-REFERENCE TO RELATED APPLICATIONS

Not applicable.

### FIELD OF THE INVENTION

The invention relates to the busbar structure with metal body, which provides protection against burning, used for energy transfer between the panel, transformer and generator in energy distribution systems.

In particular, the invention relates to the busbar structure with metal body, which ensures better discharge of the internal heat generated by the busbars during normal operation, prevents combustion and stops the progression of combustion, in environments that require the power line to be IP68 against the environmental water threat and where IP68 busbar structures are used.

### BACKGR0UND OF THE INVENTION

Today, modular compact conductors called busbars are used in energy distribution systems. Each conductor, called busbar, is more preferred because it has high current carrying properties.

Busbar lines are modular and consist of end-to-end modules. In order to carry electricity from one point to another, a line is created by adding modules end to end. The transportation of electricity is provided by long lines created with these modules. The environmental conditions of the regions where these lines pass determine the structure of the busbar modules to be used in the lines.

Busbar modules are produced in standard lengths. For the continuation of the electricity distribution line, these modules are added to each other with the additional module and closed by pouring resin into the joint area. In this way, long busbar lines are formed.

In IP68 busbar systems, where a high level of impermeability is required against water and dust, the conductors are covered with cast resin in order to operate underwater for a long time without leaking and at the same time to provide electrical internal insulation.

This material protects the voltage-bearing conductors of the distribution line, such as impact, heat load, pressurized water, dust and UV rays from the sun, and short circuit forces that may occur in its internal structure, heat loads caused by excessive current, high voltage peaks and internal arc. protects against effects that may disrupt its continuity.

In current applications, the busbar body is formed by pouring electrically insulating resinous materials around the conductors against internal and external effects, thus providing protection. This type of busbar is called Cast Resin busbar.

IP68 busbars on the market are made with a composite material consisting of resin epoxy hardener, and the busbars are completely surrounded by the material we call CAST RESIN. For this reason, fragility occurs.

The transportation and suspension problem is also due to the inability to drill holes or process the CAST RESIN material in any way.

After the CAST RESIN material is poured, the molds are removed and the cleaning process is carried out. This increases labor costs.

The dimensions of the poured resin (Cast Resin material) are made in appropriate thickness to protect the integrity of the system against the high electromagnetic forces that occur during the short circuit, as well as the internal conductors against the voltage peaks, and the devices and people in contact with the outside.

The cast resin body formed in such busbars both provides protection against external influences and serves as insulation inside. In addition, it provides cooling by throwing out the heat created by the conductors during electricity transport.

In the current technique, petroleum-derived materials such as epoxy, polyurethane and the like, which have high insulating properties due to their insulation function, have been used for years.

The biggest advantage of this material is that it isolates the conductors all around with the casting technique and provides a high level of impermeability against water and dust, and at the same time, it shows high resistance against external impacts with various additives added to the main material.

However, there are disadvantages as well as advantages. Every additive added to the base material to make it resistant to outdoor conditions reduces the insulating ability of the base material, changes the fluidity of the material, which provides production benefits, resistance to voltage peaks, and increases the release of toxic substances. On the other hand, the price-weight ratio of the main material also increases significantly and the profitability decreases.

Another important disadvantage of the main material is that it contains a high fire load since it is an oil-derived insulator material. It is the problem of burning against the flame and carrying the flame on it, thanks to its contact with air. To reduce this situation, toxic additives are added, but even if the material does not ignite, it transfers its internal energy to the external fire as a fire load and increases the fire temperature.

In the studies carried out, due to the thermal load coming from the inside or outside, combustion occurs by combining with the oxygen in the external environment and this causes the fire load energy in its structure to be released, thus increasing the energy of the external heat load and more importantly, it causes the heat load to progress and grow over the busbar line.

In the prevention studies, fire-resistant materials were used against this effect, but it was understood that in the absence of external heat loads at this time, the busbar lines were unnecessarily overheated and their electrical insulation was damaged because they could not discharge the internal heat generated during normal operation.

It is possible to make classifications for the use of the 4 criteria under the name of structure, body group, conductor group and insulation group of busbar systems used in the current technique as indicated in the table below;

TABLE
Classification of Busbars

| | | |
|---|---|---|
| STRUCTURE | H0 | With metal profile body and NON-ADHESIVE-NO CONTACT |
| | | to conductor insulation |
| | H1 | With metal profile body and ADHESIVE-CONTACT to |
| | | conductor insulation |
| BODY GROUP | G0 | Busbar without metal profile body around it |
| | G1 | Busbar with metal profile body on one side |
| | G2 | Busbar with metal profile body on two side |
| | G3 | Busbar with metal profile body on three side |
| | G4 | Busbar with metal profile body on four side |
| CONDUCTOR | P0 | bare conductors |
| GROUP | P1 | Conductors Front Insulated |
| ISOLATION | RO | Bonded around all conductors without pouring resin |
| GROUP | R1 | Resin poured around individual conductors and bonded |
| | | together |
| | R4 | Resin poured around all conductors and bonded |

In the busbar systems used in the current technique, there are busbars with the following features;
H1+G4+P1+RO
H0+G4+P0+R0
H0+G4+P1+R0
H0+G4+P0+R1
H0+G4+P0+R4
H0+G0+P0+R1
H1+G3+P1+R0

Burning occurs as a result of overheating and contact with oxygen of petroleum-derived materials positioned in order to provide IP68 protection in all of the mentioned busbar systems.

In the literature, in the US patent application numbered US2014116617, it is stated that “A busway and a method of assembling the same in which a flowable, uncured epoxy is applied between insulated busbar conductors that are stacked on top of one another and inner surfaces of the busway housing into which the stacked conductors are placed to form an enclosed busway. The busbar conductors are insulated by an epoxy powder coat, which can develop pinholes during the curing of the epoxy powder. A flowable, curable dielectric material, such as epoxy, is applied between the outermost busbar conductors and the inner surfaces of the top and bottom pieces of the busway housing. Optionally, epoxy is also applied between adjacent pairs of busbar conductors, which are stacked and arranged into the housing. Pressure is applied to the housing stack, and the epoxy is allowed to cure, resulting in a busway having superior thermal performance, dielectric integrity, and mechanical strength compared to conventional busways.” statements are included.

In the mentioned application, a busbar system insulated with epoxy coating is disclosed.

Again in the literature, in the US patent document numbered U.S. Pat. No. 9,761,353, “The proposed high temperature insulated bus pipe (busbar section) is equipped with a conductive pipe having end contacts and disposed within electrical insulation, a grounding shield covering the insulation, and a case having a fire-resistant coating. A fire-resistant layer made of a cured composite material is located between the case and the shield. The composite material includes a filler composed of thermally expandable graphite, and a binder configured to form cavities in the fire-resistant layer when the busbar section is exposed to heating. The case is made of a non-magnetic material and is formed as a plain or corrugated vacuum-proof tube. The thickness of fire-resistant layer depends on the cross-section area of conductive pipe and configuration thereof. The binder includes epoxy resin combined with curing agent. The dimension of graphite particles are specified and provided as loose powder or powder whose particles are affixed to a substrate.” statements are included.

In the mentioned application, the production of a busbar system with insulation against high temperatures is explained.

Due to the reasons mentioned above, there was a need for busbar construction with a metal body that provides protection against burning.

### PURPOSE OF THE INVENTION

Based on this position of the technique, the aim of the invention is to present a busbar structure with metal body that eliminates the existing disadvantages and provides protection against burning.

Another aim of the invention is to present a structure that prevents fire that may occur as a result of heating of busbar conductors.

Another aim of the invention is to present a structure that allows better discharge of the internal heat generated by the busbars during normal operation.

Another aim of the invention is to present a structure that stops the progression of combustion in busbar systems.

Another aim of the invention is to provide a lower cost structure, which reduces the amount of petroleum-derived insulating material used in the interior, since the metal coating increases resistance against external impacts.

Another aim of the invention is to present a structure that improves cooling even more since the amount of petroleum-derived insulating material is reduced.

Another aim of the invention is to present a structure that provides double insulation in busbar systems.

Another aim of the invention is to provide a structure with a lower impedance.

Another aim of the invention is to provide a lighter and reusable structure.

### BRIEF SUMMARY OF THE INVENTION

The present invention is busbar structure with a metal body, which ensures better discharge of the internal heat generated by the busbars during normal operation, prevents combustion and stops the progression of combustion, in environments that require the power line to be IP68 against the environmental water threat and where IP68 busbar structures are used. The busbar structure has pre-insulated conductors providing energy transmission. An upper metal barrier is formed on the upper side of the conductors and increases the resistance of the busbar structure against external impacts. A lower metal barrier is formed on the underside of the conductors and increases the resistance of the busbar structure against external impacts. A left metal barrier is formed on the left side of the conductors and increases the resistance of the busbar structure against external impacts. A right metal barrier is formed on the right side of the conductors and increases the resistance of the busbar structure against external impacts. Petroleum-derived in-frame resin is filled to the inner part of the frame on the side of the conductors, formed by the combination of the upper metal barrier, the lower metal barrier, the left metal barrier and the right metal barrier in a rectangular form, on the side of the conductors, in such a way that there is no air gap between them, which are in adhesive contact with the inner sides of the upper metal barrier, the lower metal barrier, the left metal barrier and the right metal barrier and in case of overheating of said conductors, non-combustible petroleum-derived in-frame resin because it does not contain oxygen, which carries out the combustion process, due to zero air gap.

In an embodiment, the busbar structure has individual resin around the conductor formed to ensure that the conductors are double insulated.

In an embodiment, the frame resin and conductive surrounding resin material contains epoxy hardener and silica sand.

In an embodiment, the busbar structure contains cooling channels formed on the upper metal barrier, lower metal barrier, left metal barrier and right metal barrier to allow the busbar structure to cool faster.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a cross-sectional view of the busbar structure with metal body that provides protection against combustion, which is the subject of the invention.

FIG. 2 is a cross-section view of an alternative application of the busbar structure with metal body, which is the subject of the invention, providing protection against combustion.

### REFERENCE NUMBERS

A—Busbar Structure
1. Upper Metal Barrier
2. Lower Metal Barrier
3. Left Metal Barrier
4. Right Metal Barrier
5. In-Frame Resin
6. Conductors
7. Resin Around Conductor
8. Cooling Channels

### DETAILED DESCRIPTION OF THE INVENTION

In this detailed explanation, the innovation that is the subject of the invention is only explained with examples that will not have any limiting effect for a better understanding of the subject.

The invention relates to the busbar structure (A) with metal body, which ensures better discharge of the internal heat generated by the busbars during normal operation, prevents combustion and stops the progression of combustion, in environments that require the power line to be IP68 against the environmental water threat and where IP68 busbar structures are used; characterized in that, comprises pre-insulated conductors (6) providing energy transmission, the upper metal barrier (1), which is formed on the upper side of the said conductors (6) and increases the resistance of the said busbar structure (A) against external impacts, the lower metal barrier (2), which is formed on the underside of the said conductors (6) and increases the resistance of the said busbar structure (A) against external impacts, the left metal barrier (3), which is formed on the left side of the said conductors (6) and increases the resistance of the said busbar structure (A) against external impacts, the right metal barrier (4), which is formed on the right side of the said conductors (6) and increases the resistance of the said busbar structure (A) against external impacts, petroleum-derived in-frame resin (5) which is filled to the inner part of the frame on the side of the conductors (6), formed by the combination of the said upper metal barrier (1), the lower metal barrier (2), the left metal barrier (3) and the right metal barrier (4) in a rectangular form, on the side of the conductors, in such a way that there is no air gap between them, which are in adhesive contact with the inner sides of the upper metal barrier (1), the lower metal barrier (2), the left metal barrier (3) and the right metal barrier (4) and in case of overheating of said conductors (6), non-combustible petroleum-derived in-frame resin (5) because it does not contain oxygen, which carries out the combustion process, due to zero air gap.

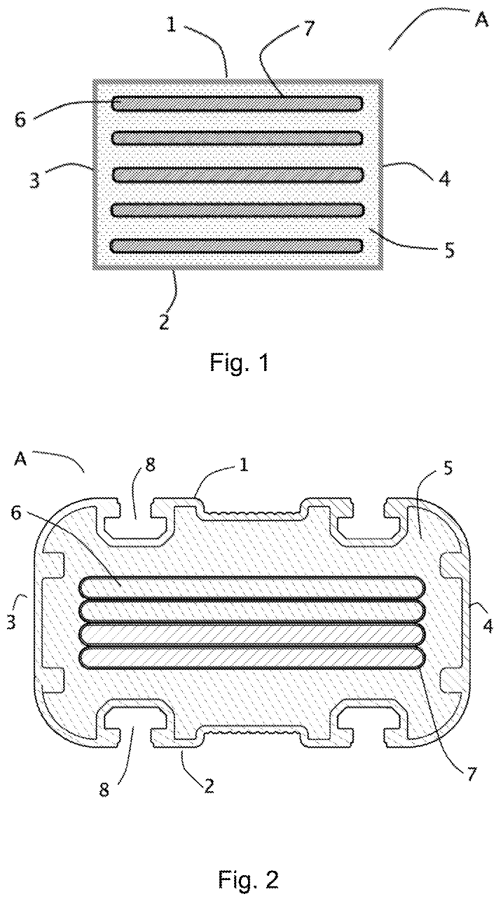

FIG. 1 shows a cross-sectional view of the busbar structure (A) with metal body that provides protection against combustion, which is the subject of the invention

FIG. 2 shows a cross-section view of an alternative application of the busbar structure (A) with metal body, which is the subject of the invention, providing protection against combustion.

The busbar structure (A) according to invention, consists main parts of pre-insulated conductors (6) providing energy transmission, the upper metal barrier (1), which is formed on the upper side of the said conductors (6) and increases the resistance of the said busbar structure (A) against external impacts, the lower metal barrier (2), which is formed on the underside of the said conductors (6) and increases the resistance of the said busbar structure (A) against external impacts, the left metal barrier (3), which is formed on the left side of the said conductors (6) and increases the resistance of the said busbar structure (A) against external impacts, the right metal barrier (4), which is formed on the right side of the said conductors (6) and increases the resistance of the said busbar structure (A) against external impacts, petroleum-derived in-frame resin (5) which is filled to the inner part of the frame on the side of the conductors (6), formed by the combination of the said upper metal barrier (1), the lower metal barrier (2), the left metal barrier (3) and the right metal barrier (4) in a rectangular form, on the side of the conductors, in such a way that there is no air gap between them, which are in adhesive contact with the inner sides of the upper metal barrier (1), the lower metal barrier (2), the left metal barrier (3) and the right metal barrier (4) and in case of overheating of said conductors (6), non-combustible petroleum-derived in-frame resin (5) because it does not contain oxygen, which carries out the combustion process, due to zero air gap, individual resin around conductor (7) formed to ensure that the conductors (6) are double insulated and cooling channels (8) formed on said upper metal barrier (1), lower metal barrier (2), left metal barrier (3) and right metal barrier (4) in order to ensure faster cooling of said busbar structure (A).

In order to prevent the combustion problem of the mentioned busbar configuration (A), the internal petroleum-derived in-frame resin (5) must be completely cut off from oxygen, and at the same time, the busbar configuration (A) must not exceed the temperature limits specified in the standards during normal operation.

In the studies carried out for this purpose, the entire perimeter of the petroleum-derived in-frame resin (5) surrounding the outer body of the conductors (6) was covered with a rectangular frame formed by combining the upper metal barrier (1), the lower metal barrier (2), the left metal barrier (3) and the right metal barrier (4) of sufficient thickness to have zero air gap.

The connection between the petroleum-derived in-frame resin (5) material in the interior and the oxygen in the exterior is reduced to zero. Likewise, the application is made in a way that there is zero air gap in the interior.

In the studies carried out, it has been observed that the internal heat of the busbar during normal operation is discharged better thanks to this method, and at the same time, since the connection of the resin material with oxygen to zero, the formation of combustion is prevented and the progression of the combustion is stopped.

On the other hand, thanks to the upper metal barrier (1), the lower metal barrier (2), the left metal barrier (3) and the right metal barrier (4), the amount of petroleum-derived insulating material used in the interior is reduced, as the resistance against external impacts increases. This further improves cooling.

In addition, in an alternative embodiment of the invention, cooling channels (8) are formed on the upper metal barrier (1), the lower metal barrier (2), the left metal barrier (3) and the right metal barrier (4), allowing it to cool much more quickly.

In the preferred embodiment of the invention, in-frame resin (5) and the resin around conductor (7) material are composed of cast resin material called Cast Resin, epoxy hardener and silica sand.

1. A busbar structure with a metal body, which ensures better discharge of internal heat generated by the busbars during normal operation, prevents combustion and stops progression of combustion, in environments that require the power line to be IP68 against the environmental water threat and where IP68 busbar structures are used, said busbar structure comprising pre-insulated conductors providing energy transmission, an upper metal barrier which is formed on an upper side of the conductors and increases the resistance of the said busbar structure against external impacts, a lower metal barrier which is formed on an underside of the said conductors and increases the resistance of the said busbar structure against external impacts, a left metal barrier which is formed on a left side of the said conductors and increases the resistance of the said busbar structure against external impacts, a right metal barrier which is formed on a right side of the said conductors and increases the resistance of the said busbar structure against external impacts, petroleum-derived in-frame resin which is filled to an inner part of the frame on the side of the conductors, formed by a combination of the said upper metal barrier, the lower metal barrier, the left metal barrier and the right metal barrier in a rectangular form, on the side of the conductors, in such a way that there is no air gap between them, which are in adhesive contact with the inner sides of the upper metal barrier, the lower metal barrier, the left metal barrier and the right metal barrier and in case of overheating of said conductors, non-combustible petroleum-derived in-frame resin because it does not contain oxygen, which carries out the combustion process, due to zero air gap.

2. The busbar structure according to claim 1, comprising individual resin around the conductor formed to ensure that the conductors are double insulated.

3. The busbar structure according to claim 2, said frame resin and conductive surrounding resin material contains epoxy hardener and silica sand.

4. The busbar structure according to claim 1, comprising cooling channels formed on the said upper metal barrier, lower metal barrier, left metal barrier and right metal barrier to allow said busbar structure to cool faster.
